(19) United States
(12) Patent Application Publication
(10) Pub. No.: US 2007/0114840 A1
(43) Pub. Date: May 24, 2007

(54) Piston-type accumulator

(75) Inventors: Rudiger Briesewitz, Bruchkobel (DE); Albrecht Otter, Schoneck (DE); Dieter Dinkel, Schwalbach (DE); Hans-Georg Zentgraf, Russelsheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co., oHG

(21) Appl. No.: 10/562,024

(22) PCT Filed: Apr. 19, 2004
(86) PCT No.: PCT/EP04/50848

§ 371 Date: Dec. 22, 2005

(30) Foreign Application Priority Data
Jun. 26, 2003 (DE) 103 28 809.0
Dec. 16, 2003 (DE) 103 58 847.7

(51) Int. Cl. B60T 17/04

(52) U.S. Cl. 303/87

(57) ABSTRACT

A piston-type accumulator, with an axially movable piston (8) in a housing bore (5), includes a seal (4) interposed between the piston (8) and the housing bore (5), which is fixed inside the housing bore (5), and a cover (6) for closing the housing bore (5). The housing bore (5) is designed as a stepped bore enlarged in diameter in the direction of the cover (6) for the simple accommodation of the seal (4).

### BACKGROUND OF THE INVENTION

The present invention relates to a piston-type accumulator, in particular a low-pressure accumulator for slip-controlled hydraulic brake systems for motor vehicles, with an axially movable piston in a housing bore, with a seal interposed between the piston and the housing bore and being fixed inside the housing bore, and with a cover for closing the housing bore.

DE 10236966 A1 discloses a pair of piston-type accumulators in a hydraulic unit for slip-controlled motor vehicle brake systems. Each piston is arranged in an axially movable manner within a seal which is fixed in a housing bore of the hydraulic unit. The housing bore is closed by means of a cover. An annular groove is provided in the housing bore in order to fix the seal, necessitating a high degree of manufacturing effort in terms of its arrangement. Prior to the installation of the piston in the housing bore, provisions must be made to ensure that the seal is fitted correctly in the annular groove. Otherwise, fitment of the piston may cause damage to the seal or, under certain circumstances, induce the seal to roll out of the housing bore, what can be detected only by means of a leakage test of the piston-type accumulator.

In view of the above, an object of the invention is to provide a simple, operationally safe piston-type accumulator which does not suffer from the above-mentioned drawbacks.

### SUMMARY OF THE INVENTION

According to the invention, this object is achieved for a piston-type accumulator of the indicated type in that the housing bore (5), at its end closed by the cover (6), is designed as a stepped bore enlarged in diameter in which the seal (4) is fixed.

The invention relates to a novel piston-type accumulator wherein the housing bore is designed as a blind-end bore, the open end of which remote from the bore bottom is continued in an outward direction as an enlarged stepped bore in order to safeguard a simplest possible and nevertheless safe accommodation of the seal in the housing bore. Arranging the seal in the stepped bore can favorably be carried out in two assembly variants, and namely either before the installation of the piston into the housing bore or, what is preferred, after the installation of the piston into the housing bore, for what purpose the end of the piston body has a chamfer.

The stepped bore allows preventing damage to the seal or, respectively, instantaneously detecting an already damaged seal. Another advantage can be seen in the far outwards disposed arrangement of the seal in the stepped bore, with the result that the piston during its working stroke can be wetted with the accumulator fluid in the housing bore and, thus, also lubricated almost over the total length of its piston body. Dry running and inadmissible piston friction is thus successfully avoided in a surprisingly simple fashion. Due to the large-surface wetting of the hosing bore up to the seal, the oxygen of the atmospheric air is furthermore kept away from the housing bore and the sliding surface of the piston so that oxidation or corrosion of the housing wall and the peripheral surface (sliding surface) of the piston can be ruled out.

Further features, advantages and possible applications of the invention and will be explained in detail by way of the description of two embodiments.

### BRIEF DESCRIPTION OF THE DRAWINGS

In the accompanying drawings:

FIG. 1 is a longitudinal cross-sectional view of a first embodiment of the invention for a piston-type accumulator that is arranged within an ABS hydraulic unit.

FIG. 2 is a longitudinal cross-sectional view of a second embodiment of the invention for a piston-type accumulator, which shows an alternative for the fixation of the seal in the piston-type accumulator of the ABS hydraulic unit.

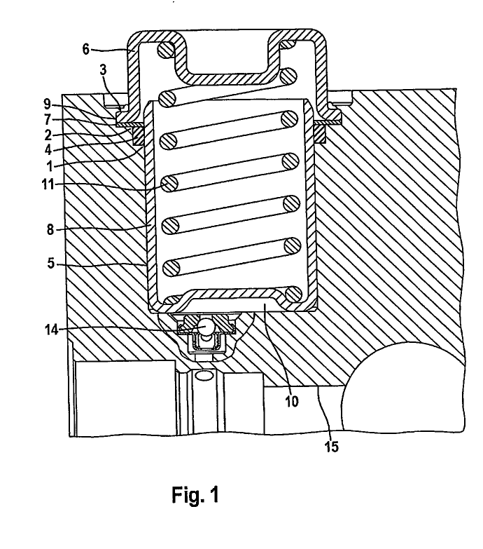

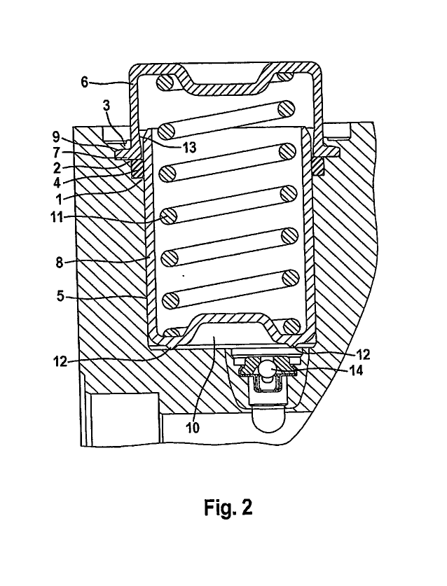

FIGS. 1 and 2 show in each case a piston-type accumulator as an example in the function of a low-pressure accumulator for a slip-controlled motor vehicle brake system, with each one axially movable piston 8 inside a housing bore 5, with a seal 4 being arranged between the piston 8 and the housing bore 5 that is fixed inside the housing bore 5. The housing bore 5 is closed by a cover 6 in a gas-proof manner.

The invention arranges for the housing bore 5 to be configured at its end closed by cover 6 as a stepped bore enlarged in its diameter, in which the seal 4 is fixed in a particularly simple and operationally safe manner.

Reference is made to the previous page 2 of the description as regards the advantages which are achieved due to the design of the two piston-type accumulators of the invention.

Both in the embodiment of FIG. 1 and that of FIG. 2, the stepped bore is subdivided into at least one first and one second bore step 1, 2. To properly guide the piston and to additionally support the seal 4 on the first bore step 1, the diameter of the stepped bore in the area of the first bore step 1 corresponds to the inside diameter of the housing bore 5.

The wall of the second bore step 2 is used to axially introduce and radially support the seal 4 within the stepped bore, to what end the stepped bore has an enlarged inside diameter between the first and second bore steps 1, 2 which is adapted to the outside diameter of the seal 4. The vertical interval of the second bore step 2 with respect to the first bore step 1 corresponds to the height of installation needed for the seal 4.

Further, the stepped bore in FIGS. 1 and 2 has a third bore step 3 before the ‘atmospheric’ outside edge of the housing bore 5, said bore step 3 being formed by the plastic deformation of the housing material of the housing bore 5 which fixes the cover 6 in the stepped bore.

Besides, it can be seen in FIGS. 1, 2 that a retaining part 7 is provided between the second and the third bore step 2, 3 in order to fix the seal 4 in its axial position at the first bore step 1 in a way as simple and operationally safe as possible. To this end, the retaining part 7 is directly supported on the second bore step 2 and covers the seal 4 at least in part in the direction of the peripheral piston surface (piston body). The outside diameter of the retaining part 7 is always adapted to the diameter of the stepped bore, and the inside diameter of the retaining part 7 is always adapted to the outside diameter of the piston 8 guided in the housing bore 5.

In a first embodiment of FIG. 1, the retaining part 7 is configured as an annular washer which is pressed radially by an edge 9 of the cover 6 that closes the housing bore 5 both against the second bore step 2 and against the seal 4.

As an alternative of the retaining part 7 being designed as an annular washer that is to be placed separately into the stepped bore, FIG. 2 shows the retaining part 7 as being formed directly by the edge 9 of a cover 6 closing the housing bore 5. For this purpose, the thin-walled edge 9 of the essentially bowl-shaped cover 6 is bent off at angles, that means, in a horizontally outward direction, in order to provide the contour of an annular washer. To attach the cover and fix the retaining part 7 on the second bore step 2, the outside surface of the bent-off edge 9 is covered by the plastically deformed housing material of the hydraulic unit.

The cover 6 as well as the piston 8 are configured like a bowl that is preferably deepdrawn both in FIGS. 1 and 2, the inside diameter of the bowl in the area of the edge 9 having a minimum clearance with regard to the outside diameter of the piston 8 for the safe fixation of the seal 4 in the embodiment of FIG. 2.

According to FIG. 2, the bowl contour of cover 6, succeeding the minimum clearance in the direction of the bowl bottom, has a portion 13, the inside diameter of which is expanded like a funnel in order to allow a generously tolerated introduction of the piston 8 into the bowl. This is advantageous because a sufficient radial space is available in the cover 6 in order to ensure an unimpeded (clamping-free) upward stroke of the piston 8 in opposition to the compression spring 11 that is compressed between the piston 8 and the cover 6 during the charging phase of the piston-type accumulator, this means when fluid flows into the chamber 10 of the housing bore 5 that is disposed below the bowl bottom.

Thus, the wall thickness of the cover 6 is increased in FIG. 2 in the direction of the edge 9 that is bent off at right angles and forms the retaining part 7, with the result of achieving a particularly stiff supporting structure in the area of the cover edge which is highly loaded mechanically. This allows accommodating the calking force at the edge 9, which develops during the plastic deformation of the housing material, in a distortion-free manner for the purpose of attaching the cover. In addition, the stiff supporting structure of the edge 9, which simultaneously assumes the function of the retaining part 7 in FIG. 2, allows taking up an especially high bursting pressure from the cover 6.

In FIG. 2, the thin-walled deep-drawn piston bottom includes small-surface supporting noses 12 in the direction of the bottom of the housing bore 5, said noses preventing the piston 5 from undesirably adhering or clinging to the bottom of the housing bore 5 in the illustrated uncharging position of the piston-type accumulator.

As an almost unmodified effective piston surface is available due to the supporting noses 12 both during charging and discharging the piston-type accumulator, an improved response behavior will be achieved under all operating conditions.

The piston-type accumulator in FIGS. 1, 2 is connected to the suction side of an ABS pump in a discharging operation by way of a non-return valve 14 inserted in the bottom of the housing bore 5, the ABS pump being inserted in a pump accommodating bore 15 downstream of the non-return valve 14. For charging the piston-type accumulator, an additional hydraulic channel, which is not shown in the Figures though, opens into the bottom of the housing bore 5 and is in connection to the brake pressure reduction valves of the ABS hydraulic unit.

Due to the coordinated structural measures being explained herein, any inclusion of air that possibly exists between the piston 8 and the cover 6 has no effect on the operational performance of the piston-type accumulator so that ventilating and bleeding of the cover 6 can favorably be omitted.

The operational characteristics of the piston-type accumulator, in particular the storage volume in the chamber 10, can optionally be adjusted in a favorable manner by the variation of the compression spring 11 and/or the depth gauge in the cover 6 into which the chamfered open end of the piston 8 plunges during the accumulator charging operation.

The seal 4 is preferably configured as an elastomeric shaped ring, especially as an O-ring, in FIGS. 1, 2. When requested or required, alternative embodiments are of course feasible. It is likewise feasible to deviate from the illustrated type of construction of the compression spring 11, the cover 6, and the piston 8 without departing from the idea of the invention.

In FIGS. 1, 2, the piston bottom and the cover bottom are retracted for centering the compression spring 11 in the direction of the two wire coil ends. Variations in this respect are also possible when requested or required without influencing the idea of the invention though.

1.-11. (canceled)

12. A Piston-type accumulator, with an axially movable piston in a housing bore, with a seal interposed between the piston and the housing bore and being fixed inside the housing bore, and with a cover for closing the housing bore,
wherein the housing bore (5), at its end closed by the cover (6), is designed as a stepped bore enlarged in diameter in which the seal (4) is fixed.

13. The piston-type accumulator as claimed in claim 12,
wherein a first and a second bore step (1, 2) are arranged inside the stepped bore, and the diameter of the stepped bore in the area of the first bore step (1) corresponds to the inside diameter of the housing bore (5), while the inside diameter of the stepped bore in the area of the second bore step (2) is adapted to the outside diameter of the seal (4).

14. The piston-type accumulator as claimed in claim 12,
wherein the stepped bore at the outside edge of the housing bore (5) is limited by a third bore step (3) which is formed by a plastic deformation of the housing material which fixes the cover (6) at the stepped bore.

15. The piston-type accumulator as claimed in claim 13,
wherein a retaining part (7) is provided between the second and the third bore step (2, 3) in order to fix the seal (4) at the first bore step (1).

16. The piston-type accumulator as claimed in claim 15,
wherein the retaining part (7) bears directly against the second bore step (2), and wherein the seal (4) is covered by the retaining part (7) at least in part in the direction of the peripheral piston surface.

17. The piston-type accumulator as claimed in claim 15,
wherein the retaining part (7) is configured as an annular washer which is pressed by a cover (6) that closes the housing bore (5) against the second bore step (2) and against the seal (4).

18. The piston-type accumulator as claimed in claim 15,
wherein the outside diameter of the retaining part (7) is adapted to the diameter of the stepped bore, and the inside diameter of the retaining part (7) is adapted to the outside diameter of a piston (8) guided in the housing bore (5).

19. The piston-type accumulator as claimed in claim 15,
wherein the retaining part (7) is formed directly by the edge (9) of a cover (6) that closes the housing bore (5).

20. The piston-type accumulator as claimed in claim 19,
wherein the edge (9) of the essentially bowl-shaped cover (6) is bent off at right angles in an outward direction in order to provide the contour of an annular washer and is covered outside by the plastically deformed housing material.

21. The piston-type accumulator as claimed in claim 12,
wherein the cover (6) is configured as a bowl, the inside diameter of the bowl in the area of the edge (9) having a minimum clearance with regard to the outside diameter of the piston (8) in order to fix the seal (4).

22. The piston-type accumulator as claimed in claim 21,
wherein the bowl is a deep-drawn part.

23. The piston-type accumulator as claimed in claim 21,
wherein, in the working stroke area of the piston (8), the bowl has at least one portion (13) in the direction of the bowl bottom, the inside diameter of which is expanded like a funnel in the direction of the bowl bottom in order to allow a generously tolerated passage of the piston (8).
